(19) United States
(12) Patent Application Publication
(10) Pub. No.: US 2026/0200324 A1
(43) Pub. Date: Jul. 16, 2026

(54) Method and Device for Calibrating an Interior Tracking System for Tracking a Position of a Head-Mounted Display

(71) Applicant: Bayerische Motoren Werke Aktiengesellschaft, Muenchen (DE)

(72) Inventors: Tobias BAUERNFEIND, Muenchen (DE); Wolfgang HABERL, Muenchen (DE); Philipp JURASIC, Muenchen (DE); Alan KEIM, Hallbergmoos (DE); Manfred PAULI, Bruckberg (DE)

(21) Appl. No.: 19/135,931

(22) PCT Filed: Nov. 8, 2023
(86) PCT No.: PCT/EP2023/081120

§ 371 Date: Jun. 5, 2025

(30) Foreign Application Priority Data
Jan. 25, 2023 (DE) 10 2023 101 814.0

(51) Int. Cl. B60K 35/90; G02B 27/00; G02B 27/01; G06F 3/01

(52) U.S. Cl. CPC B60K 35/90; G02B 27/0093; G02B 27/0172; G06F 3/012; G02B 2027/0138; G02B 2027/0178

(57) ABSTRACT

A method for calibrating a tracking system that determines, from the outside, a position of a head-mounted display, includes arranging a display unit in the capture range of a camera communicatively connected to the tracking system. The method includes actuating the display unit, using the tracking system, to continuously display a current system time. The method includes capturing a camera image that includes the system time. The method includes evaluating the camera image to obtain an image capture time corresponding to the system time. The method includes providing a latency based on the image capture time.

### BACKGROUND AND SUMMARY

The invention relates to head-mounted displays, in particular head-mounted displays for use in a vehicle interior. The invention further relates to head-mounted displays, whose position is determined with the assistance of an interior camera directed at the head-mounted display. Furthermore, the invention relates to methods for determining a time stamp for the time of the image capture and for calibrating an interior tracking system for a head-mounted display.

There are data glasses, also called head-mounted displays, known, which can display an image on one or two display surfaces in the field of vision of the wearer of the data glasses with the assistance of a display device. In the case of so-called augmented reality data glasses, the display surfaces can correspond to reflection surfaces, which direct the images to the eye of the wearer of the data glasses. The view openings of the data glasses are transparent, so that the real environment can be perceived through the data glasses in the usual manner. The display surfaces lie in the view openings, so that information to be displayed, for example, such as text, icons, graphics, video displays and the like, can be displayed superimposed over the perception of the environment.

As a rule, the information is presented to the wearer of the data glasses as information objects in contact-analog manner, i.e., presented such that these information objects have a specified assigned object overlaid in the real environment or is oriented to it or that the information object to be displayed is displayed in a specified alignment of the data glasses or of its wearer.

To display the information objects correspondingly in contact-analog manner on the display surfaces of the data glasses, it is necessary to know the position of the object in the environment and the perspective of the user. The perspective of the user is firmly assigned to the position of the head-mounted display in the wearing of the head-mounted display, i.e., of the 3D position and the 3D alignment of the head-mounted display.

The position of the head-mounted display can be determined by an external tracking system, in which an interior camera is directed toward the head of the wearer of the head-mounted display and the head-mounted display and the position of the head-mounted display is determined by evaluation of the camera image. As a rule, the interior camera is an infrared camera, in order to facilitate a good capture of the region of the head-mounted display, even in the event of poor lighting conditions. Such a tracking method is called outside-in-tracking and as a rule is based on a position detection model which is configured as a conventional or databased pattern or object detection model.

The tracking system can be configured or trained to assign one or several camera images, upon which a head-mounted display is presented, with the assistance of a per se known pattern detection method of a position of a head-mounted display. The position of a head-mounted display has, on the basis of the fixed vehicle position, a relation to a vehicle coordination system, which is considered a reference relation system.

The position of a head-mounted display detected in the tracking system is subsequently transmitted to the head-mounted display, so that a contact-analog display of an information object may be performed. In this regard, the position of a head-mounted display provided from the outside is frequently improved with the assistance of a sensor data infusion with captures of inside movement sensors (IMU sensors), in order to make available a position of a head-mounted display latency free in the head-mounted display.

An exact time reference to the captures of the internal movement sensors is necessary to carry out the sensor data infusion based on the camera image captured by the interior camera. In particular, the time of the capture of the camera image upon which the position determination is based must be exactly known, in order to continuously facilitate an exact position determination. To this end, the position of a head-mounted display transmitted from the tracking system to the head-mounted display is provided with a time stamp, which assigns a corresponding time to the position of a head-mounted display, for which the position of the head-mounted display was presented.

However, the operation of the tracking system and an associated interior camera system are not synchronized to each other, so that a latency occurs between the capture of the camera image and the storage of the camera image in the tracking system. However, conventional interior cameras are not equipped to realize a synchronization function for the provision of a time synchronization between the interior camera and the tracking system.

The present invention addresses the problem of providing a method for calibrating a tracking system which makes it possible to assign an exact time stamp to the position of the head-mounted display determined from the camera image.

This problem is solved by the methods for calibrating a tracking system for an outside-in tracking of a head-mounted display, as well as by the methods for operating a tracking system, as well as the calibration arrangements, and by the tracking systems described herein.

According to a first aspect, a method for calibrating a tracking system for determining, from the outside, a position of a head-mounted display, comprising the following steps:
arranging a display unit in the capture range of a camera which is communicatively connected to the tracking system;
actuating the display unit using the tracking system in order to continuously display a current system time of the tracking system;
capturing a camera image, which includes the system time, with the camera;
evaluating the camera image in order to obtain an image capture time corresponding to the system time;
providing a latency on the basis of the image capture time, in order to evaluate camera images captured during the operation of the tracking system for determining a position of a head-mounted display and to provided with a time stamp depending on the latency.

The tracking of a head-mounted display can occur with the assistance of a tracking system outside of the head-mounted display, which at regular times transmits a position of the head-mounted display to the head-mounted display. However, as a rule, the refresh rate is not sufficient to achieve a latency-and jerk-free contact-analog representation in the head-mounted display. With the aid of a sensor infusion, the transmitted position in the head-mounted display is used in order to continuously provide a current position of the head-mounted display with comparatively high time resolution proceeding from the time of the presence of the position of the head-mounted display through sensor data (acceleration data) of a head-mounted display motion sensor (IMU sensors). However, the sensor data of the head-mounted display sensor capture only relative movements of the head-mounted display, which are accumulated by single or double integration.

In the process, a growing integration error occurs, which is corrected based on the position of the head-mounted display provided from the outside.

Therefore, the synchronicity of the in-contact-analog manner display to the events of the environment depends considerably on the precision of the position in the head-mounted display. Therefore, the position of the head-mounted display to be tracked that is transmitted to the head-mounted display must be provided with a high precision time stamp in order to facilitate the sensor fusion in the head-mounted display such that the current position of the head-mounted display is provided as precisely as possible.

To this end, the method in the tracking system outside of the head-mounted display provides for capturing a camera image of the user of the head-mounted display with the aid of an interior camera, detecting the head-mounted display with the aid of a pattern detection algorithm of a pattern detection method in the camera image and determining with the help of a pattern comparison the location and the position of the head-mounted display in space.

To this end, the camera image is captured by the interior camera and transmitted to the tracking system via a data connection. The captured camera image can be stored in a memory of the tracking system. Subsequently, the evaluation of the camera image takes place in the tracking system in order to determine the position of the head-mounted display. Both the transmission of the camera image to the memory of the tracking system and the evaluation of the camera image in the tracking system for determination of the position of the head-mounted display result in a latency, which as a rule is not generally known. Although the processing latency time (calculation time), which the pattern detection algorithm requires, is well estimated and can be considered in the determination of the time stamp for the determined position of the head-mounted display, the latency time between the capture of the camera image (image capture time) and the storage in the memory of the tracking system depends considerably on the system components, such as type of interior camera, properties of the data transmission and the like. In particular, in the case of changing manufacturers of interior cameras the latency between capture and provision of the camera image in the memory of the tracking system is therefore difficult to predict. Hence, the total latency between the capture time of the camera image and the provision of the determined position of the head-mounted display in the tracking system is unknown and must therefore be determined with the aid of a calibration method.

In this regard, an arrangement is provided which performs an optically perceptible display in the capture range, which is captured at the time of the capture of the camera image. This display is configured such that it provides a clear indication via a current system time of the tracking system. For example, a low-latency display device, e.g., in the form of a screen display or of an LED matrix, is used, which displays a system time synchronized with the tracking system or is directly actuated by the tracking system, in order to display a system time display.

By corresponding output of a system time during the capture of camera images a visual time stamp is hence contained in each of the camera images. This visual time stamp, which is captured by the system time display in the camera image, may now be evaluated together with the position determination by the pattern detection method. To this end, the pattern detection method can evaluate the information of the system time and directly assign the corresponding system time as a time stamp to the captured camera image.

In addition, a storage time can be captured as a time of the storage of the camera image, wherein the transmission latency is determined as a difference between the storage time and the image capture time.

Since the time of the storage of the camera image in the memory of the tracking system is hence also known, the image capture time can be determined as transmission latency time and which is assigned to the memory time as latency of the transmission of the camera image to the memory of the tracking system can be determined and considered. In particular, the system time which arises from the system time of provision of the position of the head-mounted display at the conclusion of the pattern detection method minus the transmission latency time determined by the calibration method and the known processing latency time can be assigned to a position of the head-mounted display.

The above calibration makes it possible to use any type of camera as an interior camera, without said camera having to comprise functions for determining a time stamp of a captured camera image.

Provision can be made that the display unit is wire connected to the tracking system and in particular in LED panels, comprises a seven-segment display or a screen display.

The display unit can have a latency for representation of the system time specification of less than 5 ms, preferably of less than 1 ms.

According to a further aspect, an arrangement for calibration of a tracking system is provided, comprising:
an interior camera;
a display unit, which is connected to the tracking system, in order to represent a system time in visibly perceptible manner depending on the system time;
the tracking system, which is connected to the interior camera, in order to evaluate a camera image with the system time, in order to determine an image capture time and to provide a latency depending on the image capture time.

In addition, the tracking system may be configured to determine the system time from the camera image with the system time with the aid of a pattern detection method (vision tracking).

Embodiments will be explained in greater detail subsequently based on the attached drawing.

### BRIEF DESCRIPTION OF DRAWINGS

FIGS. 1a and 1b show schematic representations of a tracking system for an outside-in tracking of a head-mounted display in a vehicle in a cross-sectional representation and a top view of the vehicle interior;

FIG. 2 shows a schematic representation of an arrangement for calibrating a tracking system; and

FIG. 3 shows a flow chart for illustration of a method for calibrating the tracking system for determining the position of a head-mounted display.

### DETAILED DESCRIPTION OF DRAWINGS

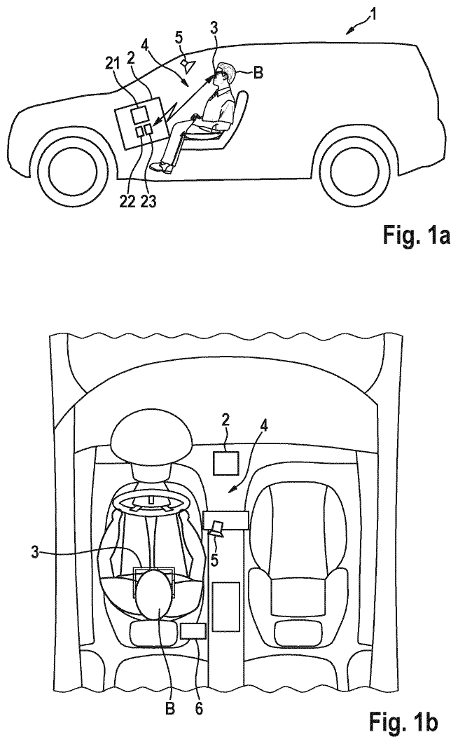

FIGS. 1a and 1b schematically show a vehicle-mounted tracking system 2 for a motor vehicle 1, which makes it possible to determine an absolute position of a head-mounted display 3 worn by a user B in a vehicle interior 4.

The head-mounted display 3 is a set of AR-glasses for augmented representation of information. For in contact-analog manner representation of information objects, a position (position and orientation of the head-mounted display) of the head-mounted display inside the head-mounted display is provided in high time resolution of between 10 and 50 Hz.

The tracking system 2 comprises a processing unit 21, a memory 22, and is connected to an interior camera 5 via a suitable data interface 23. The interior camera 5 can for example be arranged in the region of the interior mirror and is directed toward an expected position, at which an eye region of a user B of the head-mounted display 3 is located. The interior camera 5 can also be configured as a conventional optical camera or infrared camera, so that it can capture the contours of a head-mounted display 3 worn by the user B in a camera image.

The tracking system 2 is furthermore connected to the head-mounted display 3 via a preferably wireless communications connection K. The tracking system 2 is configured to transmit an externally determined position of the head-mounted display with a time stamp to the head-mounted display 3 via a corresponding communications interface. The time stamp indicates the time of the capture of the position of the head-mounted display, so that the absolute position of the head-mounted display can be merged with captures of the internal head-mounted display sensors (inertial sensors). The movement information captured in the head-mounted display 3 comprises incremental movement information (progressions of acceleration information and of angular speeds), which are accumulated by integration and the resulting position of the head-mounted display is combined by methods of sensor fusion, in order to minimize the integration errors.

In operation, the interior camera 5 can continuously capture camera images and transmit them to the memory 22 of the tracking system 2. The processing unit 21 executes a pattern detection method on the camera image whose processing latency time is in general constant and known or can be measured. Since the tracking system 2 must provide the determined position of the head-mounted display with a time stamp after its determination, along with the processing latency time the transmission latency time must also be known, which specifies the duration for the transmission of a captured camera image to the memory 22 of the tracking system 2. Thus, after the provision of the position of the head-mounted display in the tracking system 2, an image capture time can be determined by recalculating the current system time with the transmission latency time and the processing latency time, so that in this way the latency between the provision of the position of the head-mounted display with the time stamp and the image capture time can be considered.

However, as a rule the duration between the image capture time and the storage time is not known and depends considerably on the configuration of the total system, in particular of the processing times of the camera image in the selected type of interior camera, the transmission time from the interior camera 5 to the memory 22 and the time for storage in the memory 22 of the tracking system 2.

Therefore, a calibration system and a calibration method are provided, which determine the transmission latency and for consideration in the determination of the time stamp for the position of the head-mounted display provided in the tracking system 2.

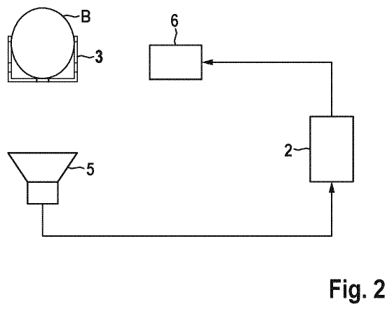

As schematically represented in FIG. 2, a display unit 6 is furthermore provided for calibration of the tracking system 2, i.e., for determining the substantially constant transmission latency.

The display unit 6 is a low-latency optical display which is directly connected to the tracking system 2, in order to be able to display instantaneously an in particular optical specification which can be captured by the interior camera 5 about the system time. This display unit 6 can for example be an LED panel, and LCD display, a micro-LED display or the like, which can be directly actuated by the tracking system 2, in particular wire connected. Preferably the display unit 6 is directly actuated by electric signals, so that in particular LED panels or seven-segment displays or the like are particularly suitable. Overall, the latency should not be more than 5 ms, preferably less than 1 ms.

The system time can be coded by the display unit 6 or displayed in readable numbers. For capture of the system time in the camera image by the interior camera 5 the display unit 6 is preferably positioned such that the system time can be captured by the camera image. Hence, information is already available in the camera image about at which image capture time the camera image was recorded.

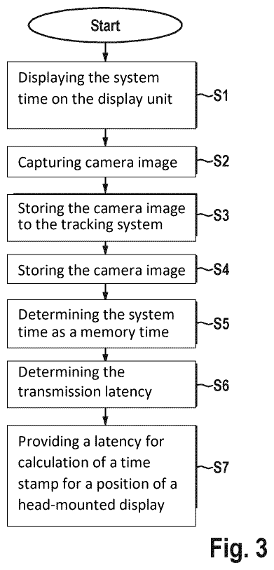

In the tracking system 2 it is now possible in a calibration method, which is illustrated on the basis of the flow chart of FIG. 3, to determine the image capture time of the camera image stored in the memory.

In step S1 the tracking system represents the current system time as a system time. The system time can be displayed digitally coded as a readable number or in other manner.

In step S2 a camera image is correspondingly captured regularly or cyclically. The system time is contained in the captured camera image.

In step S3 the captured camera image is transmitted to the tracking system 2 and in step S4 stored in the memory 22 of the tracking system 2.

Furthermore, in step S5 the system time at which the storage of the camera image in the memory 22 is concluded is captured as a storage time.

By evaluation of the camera image with the aid of conventional pattern detection methods, in step S6 the system time is identified and determined as an image capture time. The difference of the image capture time to the storage time yields the transmission latency for the transmission of the camera image to the memory 22 of the tracking system 2.

This transmission latency can be stored in the tracking system 2 in step S7, so that this can be used in the operation of the tracking system 2 for the calculation of the time stamp for positions of the head-mounted display. In addition, the well known per se processing latency is determined for the application of the pattern detection method to the camera image for determination of the position of the head-mounted display or is provided as previously known, so that a total latency results as a sum of the transmission latency and the processing latency.

### LIST OF REFERENCE NUMERALS

1 Motor vehicle
2 Tracking system
3 Position of the head-mounted display
4 Vehicle interior
21 Processing unit
22 Memory
23 Data interface
5 Internal camera
6 Display unit

1-8. (canceled)

9. A method for calibrating a tracking system configured to determine, from the outside, a position of a head-mounted display, the method comprising:
arranging a display unit in the capture range of a camera which is communicatively connected to the tracking system;
actuating the display unit, using the tracking system, to continuously display a current system time;
capturing a camera image that includes the system time;
evaluating the camera image to obtain an image capture time corresponding to the system time; and
providing a latency on the basis of the image capture time.

10. The method of claim 9, further comprising:
transferring the camera image to a memory of the tracking system;
capturing a memory time as the time of the storage of the camera image;
determining a transfer latency as the difference between the memory time and the image capture time, wherein the latency is further based on the transfer latency.

11. The method of claim 9, wherein the system time comprises numbers or a digital coding.

12. The method of claim 9, wherein the display unit is wire connected to the tracking system and comprises a seven-segment display or a screen display.

13. The method of claim 12, wherein the display unit comprises a latency for representing the system time of less than 5 ms.

14. The method of claim 9, wherein the latency further depends on a processing latency resulting from the duration of the processing of the camera image stored in the tracking system until the provision of the position of the head-mounted display determined from it.

15. A system for calibrating a tracking system, comprising:
an interior camera;
a display unit connected to the tracking system and configured to present a system time depending on the system time in a visually perceptible manner;
the tracking system connected to the interior camera and configured to evaluate a camera image with the system time to determine an image capture time and to provide a latency depending on the image capture time.

16. The system claim 15, wherein the tracking system is configured to determine the system time from the camera image with the system time with the aid of a pattern detection method.
